(19) United States
(12) Patent Application Publication
(10) Pub. No.: US 2006/0232520 A1
(43) Pub. Date: Oct. 19, 2006

(54) Organic light emitting diode display

(76) Inventors: Yong-Sung Park, Suwon-si (KR); Yojiro Matsueda, Suwon-si (KR); Sang-Moo Choi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/386,229

(22) Filed: Mar. 21, 2006

(30) Foreign Application Priority Data
Apr. 13, 2005 (KR) 10-2005-0030661

(51) Int. Cl. G09G 3/30

(52) U.S. Cl. 345/76

(57) ABSTRACT

An OLED display device which has a peripheral circuit and a display area on the same substrate and provides enhanced gamma correction is disclosed. The OLED display includes a plurality of pixels, a resistor ladder, a predetermined number of voltage selectors, and a data driver, all of which are formed on the same substrate. The resistor ladder includes a plurality of resistors arranged in series between a highest reference voltage and a lowest reference voltage. Each of the voltage selectors includes a plurality of switches coupled to the resistor ladder at a plurality of nodes such that a reference voltage is selected from a plurality of voltages. The data driver is configured to convert a grayscale video signal to a data voltage using the selected reference voltage and to transmit the data voltage to one of the pixels.

### CROSS-REFERENCE TO RELATED APPLICATIONS

This application claims the benefit of Korean Patent Application No. 10-2005-0030661 filed in the Korean Intellectual Property Office on Apr. 13, 2005, the disclosure of which is incorporated herein by reference. This application is related to U.S. patent application Ser. No. 11/385,591, filed concurrently herewith on Mar. 21, 2006 (Attorney Docket No. SDIYOU.013AUS) and entitled “ORGANIC LIGHT EMITTING DIODE DISPLAY,” which is hereby incorporated by reference herein.

### BACKGROUND OF THE INVENTION

1. Field of the Invention

The present invention relates to an organic light emitting diode (OLED) display. More particularly, the present invention relates to an OLED display device which has enhanced gamma correction and brightness.

2. Description of the Related Technology

Recently, liquid crystal and electro-luminescent organic materials have been widely used for flat panel displays. Such flat panel display devices generally employ an active matrix method for driving the display devices. The active matrix method is a driving method which uses active elements such as a transistor.

Thin film transistors (TFT) have been widely used as an active element for flat panel displays. TFTs are typically formed on an insulation substrate. Certain peripheral circuits (e.g., drivers) are formed on the insulation substrate outside a display area. A system having a display and peripheral circuits (e.g. driver) together on the same insulation substrate is referred to as a system-on-a-panel (SOP).

Generally, a display device needs gamma correction to correct a nonlinear relationship between luminance video signals and the actual brightness of a displayed image. The nonlinear relationship is also referred to as the gamma characteristic. A display device that requires a linear relationship between these quantities uses gamma correction. Gamma correction is conducted by adjusting video signals before providing the signals to the display device.

A TFT for use in an SOP-type organic light emitting diode (OLED) display typically employs polysilicon as its channel layer. The polysilicon is processed by a low temperature polysilicon (LTPS) process. The LTPS process causes deviations in the polysilicon. Thus, gamma correction values for the OLED display should be customized for each OLED display having its own unique polysilicon deviations. Therefore, a conventional gamma correction method using a single predetermined gamma correction value cannot achieve optimal gamma correction for an SOP-type OLED display.

Another consideration should be given to the ambient light of a display device. Visibility of an image displayed by a light emitting display device depends on the brightness of the ambient environment. In order to obtain superior visibility, the brightness of the display device should be adjusted based on that of the ambient light. For example, a light emitting display device should display a bright image when the ambient environment is bright. On the other hand, it should display a darker image when the ambient environment is dark. In addition, there is a need to provide a gamma correction circuit for OLEDs of different colors, each having a different gamma value.

### SUMMARY OF CERTAIN INVENTIVE ASPECTS

One aspect of the invention provides an organic light emitting diode (OLED) display. The OLED display comprises: a plurality of pixels, each of the pixels comprising at least one OLED; a reference voltage generator configured to provide a plurality of reference voltages, each of the reference voltages being adjustable for the at least one OLED; and a data driver configured to convert a digital video signal into an analog video signal and to supply the analog video signal to the plurality of pixels. The data driver is configured to provide the analog signal based on at least one of the reference voltages.

In the OLED display, each of the pixels may comprise a plurality of OLEDs, each OLED having a different color, and the reference voltage generator may be configured to provide a selected reference voltage for each OLED of a particular color. Each of the pixels may comprise a red OLED, a green OLED, and a blue OLED. The reference voltages may comprise gamma-corrected voltage values. The reference voltages may comprise voltage values adjusted according to the ambient light of the OLED display. The digital video signal may comprise grayscale data of an image to be displayed by the plurality of pixels.

In the OLED display, the reference voltage generator may comprise: a resistor ladder connected between a highest reference voltage and a lowest reference voltage, the resistor ladder comprising a plurality of resistors arranged in series between the highest and the lowest reference voltages and a plurality of nodes between adjacent pairs of the plurality of the resistors; and a plurality of voltage selectors configured to provide the plurality of reference voltages, each of the voltage selectors comprising a plurality of switches, each of the switches being coupled to a respective one of the plurality of nodes. The pixels may comprise OLEDs for a plurality of colors and the reference voltage generator may comprise a plurality of resistor ladders, each resistor ladder being associated with a respective color. The resistor ladders may be provided with different highest and lowest reference voltages for the respective color OLEDs. The reference voltage generator may further provide the highest and the lowest reference voltages as reference voltages.

The data driver may comprise: a first decoder configured to select two reference voltages from the plurality of the reference voltages according to the digital video signal; and a second decoder configured to select a reference voltage between the two selected reference voltages according to the digital video signal. The data driver may further comprise a resistor ladder; wherein the resistor ladder comprises two terminals, a plurality of resistors arranged in series between the two terminals, and a plurality of nodes between adjacent two of the resistors; wherein the two terminals are coupled to the two selected reference voltages; and wherein the second decoder is configured to select one of the two terminals and the plurality of nodes according to the digital video signal.

The second decoder may comprise a plurality of switches, each of the switches being coupled to a respective one of the two terminals and the plurality of nodes. The first decoder may be configured to select the two reference voltages according to at least one high-order bit of the digital video signal and the second decoder may be configured to select the reference voltage according to the remaining low-order bits of the digital video signal. The pixels, the reference voltage generator, and the data driver may be formed on the same panel.

Another aspect of the invention provides an organic light emitting diode (OLED) display, comprising: a plurality of pixels, each of the pixels comprising at least one OLED; means for providing a plurality of reference voltages, each of the reference voltages being adjustable for the at least one OLED; and means for supplying video signals to the plurality of pixels, using at least one of the reference voltages. In the OLED display, the video signals may comprise a gamma corrected value.

Yet another aspect of the invention provides an organic light emitting diode (OLED) display comprising: a plurality of pixels, each of the pixels comprising a plurality of OLEDs, each OLED having a different color; and means for gamma correcting analog signals provided to each OLED, wherein the analog signals are gamma-corrected using reference voltages adjustable for each OLED of a particular color. Each color OLED may have its own gamma correction. The pixels and the gamma correcting means may be formed on the same panel.

Another aspect of the invention provides an organic light emitting diode (OLED) display. The OLED display comprises: a plurality of pixels formed on a substrate; a resistor ladder formed on the substrate and including a plurality of resistors arranged in series between a highest reference voltage and a lowest reference voltage; a predetermined number of voltage selectors formed on the substrate and including a plurality of switches coupled to the resistor ladder through a plurality of nodes, such that a reference voltage is selected from among a plurality of voltages input through the nodes, using one of the plurality of switches; and a data driver formed on the substrate, for converting grayscales of a video signal corresponding to the pixels to data voltages respectively based on the reference voltage, and transmitting the data voltages to the pixels.

In the OLED display, a predetermined number of reference voltages respectively output from the predetermined number of voltage selectors may be data voltages corresponding to predetermined grayscales of the video signal that corresponds to the pixels. The grayscales of the video signal may be divided into a plurality of groups based on at least one most significant bit. The reference voltage may correspond to a specific grayscale among a plurality of grayscales included in the respective groups. The specific grayscale may correspond to a boundary of each group.

In the OLED display, the data driver may comprise: a first decoder for selecting two reference voltages corresponding to the grayscale of the video signal among the predetermined number of reference voltages; a plurality of resistors arranged in series between the two selected reference voltages; and a second decoder for selecting a node corresponding to a grayscale of the video signal among a plurality of nodes formed by the resistors arranged in series, from bits of the grayscales of the video signal excluding the at least one most significant bit. The data driver may comprise: a first decoder for selecting two reference voltages corresponding to the grayscale of the video signal among the predetermined number of reference voltages; a plurality of resistors arranged in series between the two selected reference voltages; and a second decoder for selecting a node corresponding to a grayscale of the video signal among a plurality of nodes formed by the resistors arranged in series, from bits of the grayscales of the video signal excluding the at least one most significant bit.

In the OLED display, the resistor ladder and the predetermined number of voltage selectors may be provided for first to third colors of the video signals, respectively. The highest reference voltages and the lowest reference voltages respectively applied to the resistor ladders respectively provided for the first to third colors may be set to be different from each other.

Another aspect of the invention provides an organic light emitting diode (OLED) display comprising: a plurality of pixels formed on a substrate and respectively including a plurality of subpixels of first to third colors; a first resistor provided on the substrate in a form of an electrical line having a resistance and applied with a first highest reference voltage and a first lowest reference voltage at lateral ends of the first resistor, respectively; a second resistor provided on the substrate in a form of an electrical line having a resistance and applied with a second highest reference voltage and a second lowest reference voltage at lateral ends of the second resistor, respectively; a third resistor provided on the substrate in a form of an electrical line having a resistance, and applied with a third highest reference voltage and a third lowest reference voltage at lateral ends of the third resistor, respectively; a predetermined number of first voltage selectors formed on the substrate, coupled to the first resistor through at least one first switch, for selecting a first reference voltage using the first switch; a predetermined number of second voltage selectors formed on the substrate, coupled to the second resistor through at least one second switch, for selecting a second reference voltage using the second switch; a predetermined number of third voltage selectors formed on the substrate, coupled to the third resistor through at least one third switch, for selecting a third reference voltage using the third switch; and a data driver formed on the substrate, for changing video signals respectively corresponding to the plurality of subpixels to data voltages on the basis of the first to third reference voltages, and respectively applying the data voltages to the plurality of subpixels.

In the OLED display, the pluralities of first to third reference voltages may be data voltages respectively corresponding to predetermined grayscales of the video signals corresponding to the plurality of subpixels. The data driver may comprise: a first decoder for selecting pairs of first to third reference voltages among the pluralities of first to the third reference voltages; a plurality of first resistors arranged in series between the selected pair of first reference voltages; a plurality of second resistors arranged in series between the selected pair of second reference voltages; a plurality of third resistors arranged in series between the selected pair of third reference voltages; and a second decoder for selecting a node corresponding to a grayscale of the video signal among nodes formed by the first to third resistors arranged in series, from bits of the grayscales of the video signal excluding the at least one most significant bit. The first to third highest reference voltages may be set to be different from each other and the first to third lowest reference voltages are set to be different from each other.

Yet another aspect of the invention provides a method of providing a video signal to an OLED display. The method comprises: providing a plurality of pixels, each of the pixels comprising at least one OLED; providing a plurality of reference voltages adjusted for the at least one OLED; converting a digital video signal into an analog video signal, using the at least one of the reference voltages; and providing the analog video signal to the plurality of pixels. The pixels may comprise OLEDs of at least two different colors, and providing the plurality of reference voltages comprises providing different reference voltages to the OLEDs of the different colors.

### BRIEF DESCRIPTION OF THE DRAWINGS

Aspects and advantages of the invention will become apparent and more readily appreciated from the following description, taken in conjunction with the accompanying drawings.

FIG. 1 is a schematic top plan view of an organic light emitting display according to an embodiment of the invention.

FIG. 2 is a circuit diagram of a pixel according to an embodiment of the invention.

FIG. 3 is a schematic view illustrating a data diver according to an embodiment of the invention.

FIG. 4 is a graph showing output data voltages of a digital-to-analog converter for grayscales of red video signals.

FIG. 5 is a graph showing output data voltages of a digital-to-analog converter for grayscales of green video signals.

FIG. 6 is a graph showing output data voltages of a digital-to-analog converter for grayscales of blue video signals.

FIG. 7 is a schematic view illustrating a digital-to-analog converter according to an embodiment of the invention.

FIG. 8 is schematic view illustrating a resistor ladder and a least significant bit (LSB) decoder of the digital-to-analogue converter of FIG. 7.

FIG. 9 is a schematic view illustrating a reference voltage generator according to an embodiment of the invention.

### DETAILED DESCRIPTION OF CERTAIN INVENTIVE EMBODIMENTS

An organic light emitting diode (OLED) display according to embodiments of the invention will be described in detail with reference to the accompanying drawings. In the drawings, like reference numbers indicate identical or functionally similar elements.

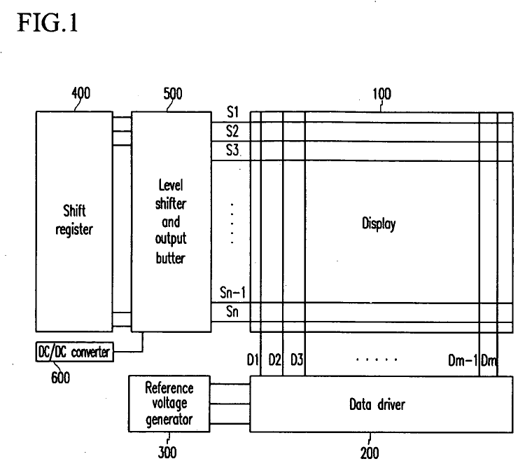

FIG. 1 is a schematic top plan view of an OLED according to an embodiment. In FIG. 1, the OLED display includes a display 100, a data driver 200, a reference voltage generator 300, a shift register 400, a level shifter and output buffer 500, and a DC/DC converter 600. All the elements are formed on the same substrate. The shift register 400 and the level shifter and output buffer 500 may be collectively referred to as a scan driver.

The display 100 includes a plurality of scan lines S1-Sn extending in a horizontal direction and a plurality of data lines D1-Dm extending in a vertical direction. Subpixels are formed at intersections of the scan lines S1-Sn and the data lines D1-Dm. The subpixels are coupled to their corresponding scan and data lines. Each of the subpixels includes a pixel driving circuit and an organic light emitting diode (OLED). The pixel driving circuit includes a thin film transistor (TFT). The scan lines S1-Sn provide selection signals to subpixels. Each of the selected subpixels is provided with a data signal from a corresponding data line. The data signal flows through the pixel driving circuit which in turn provides an electrical current to the OLED. The OLED thus emits light corresponding to the data signal. Subpixels may emit light of different colors depending on the material from which the OLED is formed. Examples of colors include red R, green G, and blue B. Hereinafter, red, green, and blue colors are also referred to as R, G, and B, respectively. In one embodiment, three subpixels which emit red R, green G, and blue B lights, respectively, may constitute one pixel. The subpixels may be arranged linearly or in a form of triangle.

The data driver 200 is configured to provide data signals to the data lines D1-Dm. In the illustrated embodiment, the data driver 200 is positioned on one side of the display 100. In other embodiments, more than one data driver may be provided on multiple sides of the display 100. For example, two data drivers may be provided on two sides of the display 100. In such a case, video signals are divided into odd-numbered and even-numbered signals. These signals are provided to first and second data drivers, respectively. In such an embodiment, the first and second data drivers are configured to transmit the odd-numbered and even-numbered data image signals, respectively, to the display 100.

The reference voltage generator 300 is configured to generate reference voltages for subpixels. The reference voltage generator 300 may provide different voltages to subpixels of different colors. In one embodiment, the reference voltage generator 300 may generate a red reference voltage, a green reference voltage, and a blue reference voltage which are different from each other in value. The reference voltage generator 300 may provide the reference voltages to a digital-to-analog converter (DAC) in the data driver 200. The data driver 200 may include DACs for the respective colors R, G, and B.

The shift register 400 is configured to sequentially output selection signals to the level shifter and output buffer 500. The level shifter and output buffer 500 receives the selection signals from the shift register 400, and changes a voltage level of the selection signal. Then, the level shifter and output buffer 500 transmits the selection signal to the scan lines S1-Sn.

The DC/DC converter 600 is configured to generate a voltage with negative polarity. The DC/DC converter 600 then transmits the voltage to the level shifter and output buffer 500. This configuration is required because a selection signal transmitted from the shift register 400 to the display 100 is typically a pulse signal that swings between positive polarity and negative polarity.

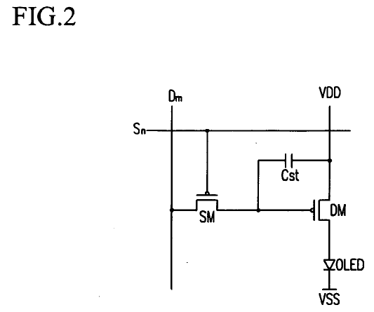

In one embodiment, a pixel circuit as shown in FIG. 2 may be provided inside a subpixel. The pixel circuit is coupled to an n-th scan line Sn and an m-th data line Dm. The pixel circuit uses an analog voltage as a data signal. “Analog voltage,” will be hereinafter referred to as “data voltage.” In one embodiment, the pixel circuit includes two PMOS transistors as shown in FIG. 2. The PMOS transistors may be formed of TFTs. In other embodiments, NMOS transistors may be used in place of the PMOS transistors with opposite signal voltage swings.

In FIG. 2, the pixel circuit includes a switching transistor SM, a driving transistor DM, a capacitor Cst, and an OLED. The switching transistor SM has a gate coupled to the scan line Sn, a source coupled to the data line Dm, and a drain coupled to a gate of the driving transistor DM. The driving transistor DM has a source coupled to a first voltage source VDD and a drain coupled to the OLED. The capacitor Cst is coupled between the gate and the source of the driving transistor DM. In addition, the OLED has an anode electrode coupled to the drain of the driving transistor DM, and a cathode electrode coupled to a second voltage source VSS. The second voltage source VSS is configured to supply a voltage lower than the first voltage source VDD.

Referring to FIG. 2, the operation of the pixel circuit is described. First, a selection signal is applied to the scan line Sn. Then, the switching transistor SM is turned on and a data voltage is transmitted to the driving transistor DM. During this time, a voltage corresponding to a voltage difference between the first voltage source VDD and the data voltage VDATA is stored in the capacitor Cst. Thus, a gate-source voltage V_{GS} of the driving transistor DM is maintained for a certain period of time. Accordingly, the driving transistor DM provides a current IOLED to the OLED. The current IOLED corresponds to the gate-source voltage V_{GS} to the OLED. The OLED emits light as the current IOLED flows through it. The current IOLED may be represented by Equation 1 below.
Equation 1

$${I}_{OLED} = \frac{β}{2} {( {V}_{GS} - {V}_{TH} )}^{2} = \frac{β}{2} {( {V}_{DD} - {V}_{DATA} - \vert {V}_{TH} \vert )}^{2}$$

In Equation 1, V_{GS} denotes the gate-source voltage of the driving transistor DM. VTH denotes a threshold voltage of the driving transistor DM. VDATA denotes a data voltage, and β denotes a constant value for the current gain of the transistor DM.

Equation 1 indicates that an amount of the current IOLED flowing to the OLED increases as the data voltage VDATA decreases. On the other hand, the current decreases as the data voltage VDATA increases. Therefore, an image at a high grayscale level can be displayed when the data voltage is low. On the other hand, an image at a low grayscale level is displayed when the data voltage is high. Equation 1 applies to a driving circuit in which the driving transistor DM is a PMOS transistor. In certain embodiments where the driving transistor DM is an NMOS transistor, an image at a high grayscale level is displayed when the data voltage is high. On the other hand, an image at a low grayscale level is obtained when the data voltage is low.

A manufacturing process of a system-on-a-panel (SOP) type of OLED display will now be described. In one embodiment, an amorphous silicon layer is deposited on an insulation substrate. The amorphous layer is crystallized to provide a channel layer for TFTs. For that purpose, the amorphous silicon layer is transformed to a polysilicon layer through a low temperature polysilicon (LTPS) process. Subsequently, the polysilicon layer is patterned to form channels of TFTs. The channels of TFTs are used for various OLED display elements, including the display 100, the data driver 200, the reference voltage generator 300, the shift register 400, and the level shifter and output buffer 500. Then, an insulation layer is formed over the channel layer. A gate electrode and a metal layer for wiring are formed over the insulation layer. Another insulation layer is formed over the metal layer. Metal layers for drain and source electrodes and for an anode electrode of the OLED are sequentially formed over the insulation layer. Subsequently, red, green, and blue OLEDs are formed of organic material over the insulation layer. Transparent cathode electrodes are formed over the OLEDs.

The method described above is used for fabricating an SOP OLED having a top gate type of TFT. The top-gate-type TFT has a gate electrode on top of a channel layer. In other embodiments, an SOP OLED may have a bottom gate type of TFT. The bottom-gate-type TFT has a gate electrode below a channel layer. A skilled technologist will appreciate that a manufacturing process of an SOP OLED having a bottom gate TFT can be easily derived from the method described above. Thus, a detailed process for an SOP OLED with a bottom gate TFT will be omitted.

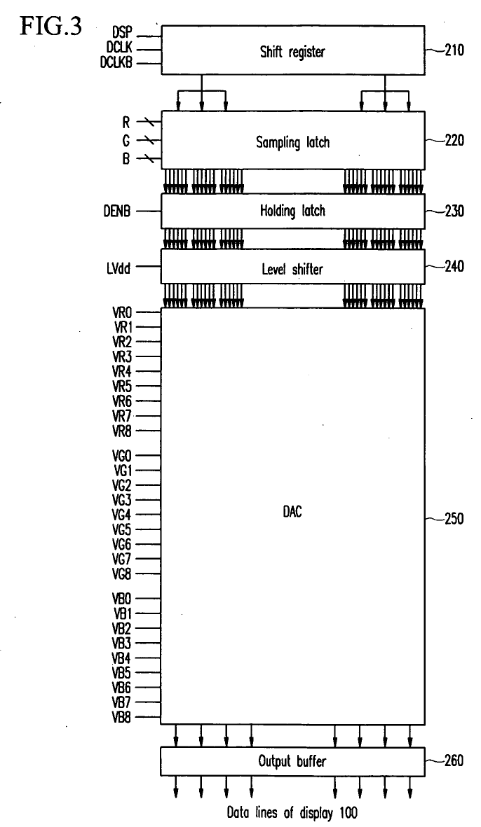

A data driver according to an embodiment will now be described with reference to FIG. 3. The data driver includes a shift register 210, a sampling latch 220, a holding latch 230, a level shifter 240, a DAC 250, and an output buffer 260.

The shift register 210 is configured to generate a sampling signal from a start signal DSP according to clocks DCLK and DCLKB. It then sequentially shifts the sampling signal according to the clocks DCLK and DCLKB and outputs a shifting result.

The sampling latch 220 is configured to latch R, G, B signals for a period of time. The sampling latch 220 includes a plurality of sampling circuits. Each of the sampling circuits sequentially samples and latches a red R digital signal, a green G digital signal, or a blue B digital signal in accordance with the sampling signals sequentially transmitted from the shift register 210.

The holding latch 230 is configured to synchronously output the R, G, and B digital signals sequentially sampled and output by the sampling latch 220 according to an enable signal DENB.

The level shifter 240 is configured to change voltage levels of the R, G, and B digital signals output from the holding latch 230. The level shifter 240 changes the voltage levels to voltage levels applicable to the DAC 250 according to an input voltage LVdd.

The DAC 250 is configured to convert the R, G, and B digital signals into analog R, G, and B data voltages applicable to subpixels of the display 100. The DAC 250 uses reference voltages VR0-VR8, VG0-VG8, and VB0-VB8 generated by the reference voltage generator 300 of FIG. 1 in the digital-to-analog signal conversion.

The output buffer 260 is configured to buffer the analog R, G, and B data voltages output from the DAC 250. It then outputs a buffering result to respective subpixels.

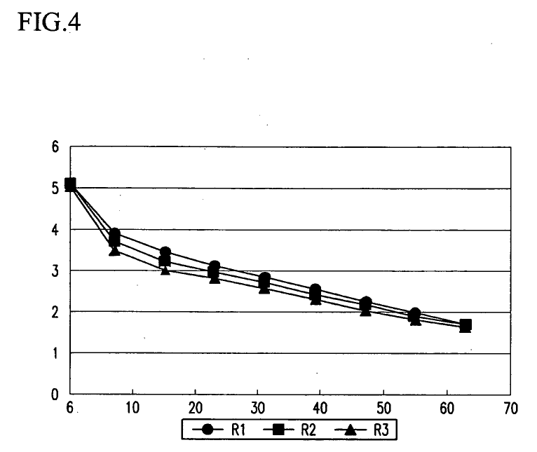

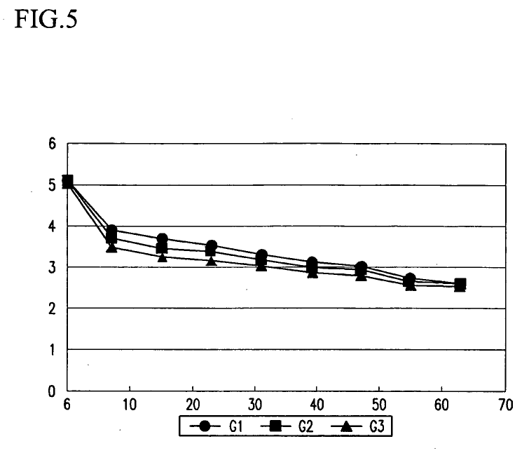

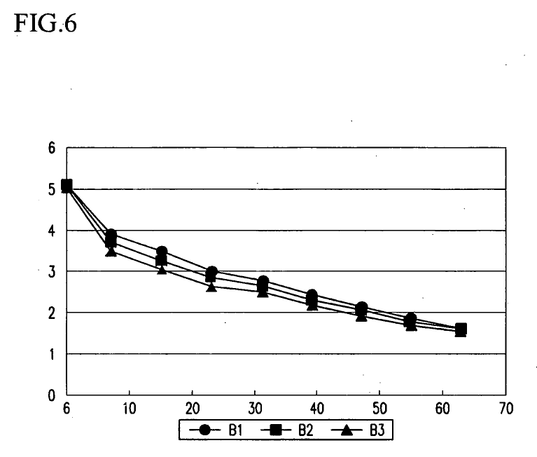

Referring to FIGS. 4-9, gamma characteristics of R, G, and B subpixels and the reference voltage generator 300 will be described. In addition, the DAC 250 which performs gamma correction on input image data will be described in detail. In the illustrated embodiment, an input image data is a 6-bit digital signal.

Referring to FIGS. 4 to 6, gamma characteristics of R, G, and B subpixels will be described. As explained above, gamma characteristic refers to a nonlinear relationship between a signal input and a displayed image. FIGS. 4, 5, and 6 illustrate gamma characteristics of R, G, and B subpixels, respectively. In FIG. 4 to FIG. 6, a horizontal axis represents grayscale levels of input image data. A vertical axis represents data voltages applied to the R, G, and B subpixels, respectively, for providing given grayscale levels.

As shown in FIGS. 4 to 6, different data voltages are applied to the R, G, and B subpixels, respectively, for providing the same grayscale. Gamma characteristics are different between red, green, and blue because organic materials for red, green, and blue OLEDs are different in gamma characteristics. Therefore, gamma correction needs to be calibrated for the respective colors.

In the illustrated embodiment, gamma correction is conducted by adjusting reference voltages for the respective colors. Referring back to FIG. 3, the DAC 250 receives 6-bit R, G, and B image data from the level shifter 240. The DAC 250 gamma-corrects the image data, using reference voltages VR0-VR8, VG0-VG8, and VB0-VB8 supplied from the reference voltage generator 300 of FIG. 1. The reference voltage generator is configured to provide color-specific reference voltages to the DAC 250.

In the illustrated embodiment, 6-bit image data is provided to each of subpixels. This configuration provides 26 or 64 grayscale levels. As shown in FIGS. 4 to 6, 6-bit image data can be divided into 8 sections based on three high-order bits, i.e., 2³=8. In FIGS. 4 to 6, circles, squares, and triangles indicate boundary points between adjacent pairs of the sections. As will be described later in detail, the reference voltage generator 300 provides reference voltages corresponding to grayscales at the boundary points. The reference voltage generator 300 is configured to vary these voltages for subpixels of different colors.

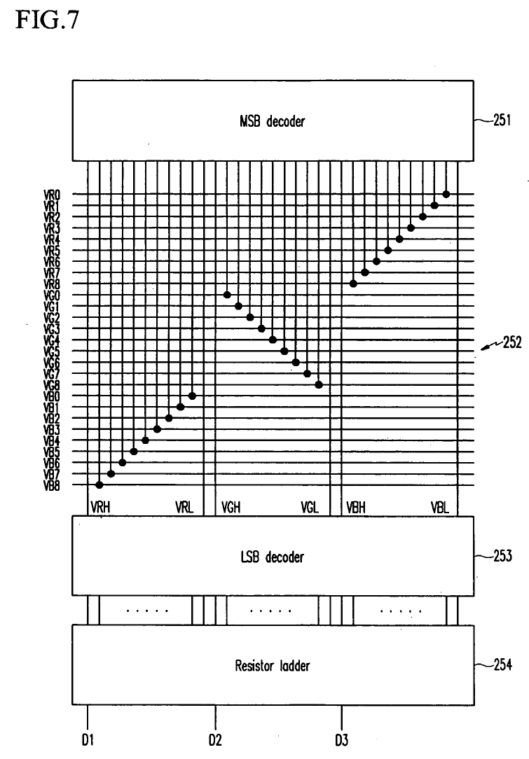

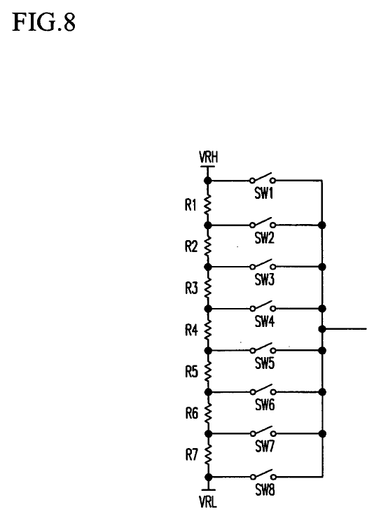

FIG. 7 illustrates the DAC 250 of FIG. 3. FIG. 8 is a schematic view of a resistor ladder 254 and a LSB decoder 253 in the DAC 250 of FIG. 7. The DAC 250 includes a plurality of DAC cells. Each of the DAC cells is connected to a plurality of data lines D1-Dm. FIG. 7 illustrates, by way of example, DAC cells connected to three data lines D1-D3. In the illustrated embodiment, the three data lines D1-D3 are coupled to R, G, and B subpixels, respectively, which are arranged in a column direction.

As shown in FIG. 7, the DAC 250 includes a most significant bit (MSB) decoder 251, a reference voltage wire unit 252, a least significant bit (LSB) decoder 253, and a resistor ladder 254. The MSB decoder 251 is configured to select two consecutive reference voltages among nine reference voltages VR0-VR8, VG0-VG8, and VB0-VB8 based on the three high-order bits of a 6-bit image data signal. The LSB decoder 253 is configured to select a voltage between the two selected reference voltages based on the three low-order bits of the 6-bit signal.

The reference voltage wire unit 252 includes nine horizontal wires to transmit R reference voltages VR0-VR8 supplied from the reference voltage generator 300 of FIG. 1. The wire unit 252 also includes nine horizontal wires to transmit G reference voltages VG0-VG8. The unit 252 also includes nine horizontal wires to transmit B reference voltages VB0-VB8. In addition, the wire unit has vertical wires, each of which is coupled to a respective one of the horizontal wires. The vertical wires are also connected to the MSB decoder 251. This configuration allows the reference voltages to be supplied from the reference voltage generator 300 to the MSB decoder 251. In addition, the wire unit 252 has additional vertical wires VRH, VRL, VGH, VGL, VBH, and VBL. These additional vertical wires are connected between the MSB decoder 251 and the LSB decoder 253. These additional wires are used for transmitting two reference voltages selected by the MSB decoder 251 to the LSB decoder 253.

A digital-to-analog conversion process using the DAC 250 will now be described in detail. By way of example, a digital-to-analog conversion process of R digital data to an R analog data voltage will be described. First, the MSB decoder 251 selects two consecutive horizontal wires among the nine horizontal wires VR0-VR8 according to the three high-order bits of a 6-bit R digital data. Then, the MSB decoder 251 connects the two selected horizontal wires via the two additional vertical wires and the LSB decoder 253 to the resistor ladder 254. By this operation, the MSB decoder 251 provides two selected reference voltages to the resistor ladder 254.

FIG. 8 illustrates a combined circuit diagram of the resistor ladder 254 and the LSB decoder 253. The resistor ladder 254 includes seven resistors R1-R7 arranged in series between the two reference voltages VRH and VRL. The LSB decoder 253 includes eight TFTs SW1-SW8 respectively coupled to the reference voltages VRH and VRL and nodes between adjacent two of the resistors. In addition, the LSB decoder 253 is configured to select and turn on one TFT from the eight TFTs SW1-SW8 according to the three low-order bits of the R digital data. Then, the LSB decoder 253 outputs an R data voltage through the selected TFT. Details of the structure of the MSB decoder 251 are not described. However, a skilled technologist will appreciate that the MSB decoder 251 may also be formed using TFTs in a manner symmetrical to the LSB decoder 253.

A method for generating data voltages for red, green, and blue colors using the DAC 250 will now be described in detail. The DAC 250 receives gamma-corrected reference voltages from the reference voltage generator 300. Subsequently, the DAC 250 divides an input image data at a predetermined interval according to grayscale levels.

As previously described, when the input image data is 6-bit, the MSB decoder 251 decodes the three high-order bits and the LSB decoder 253 decodes the three low-order bits. In the illustrated embodiment, the input image data is divided into eight sections based on the three high-order bits, that is, 23=8 sections. FIGS. 4-6 show nine boundary points including seven middle points between two adjacent sections and two end points. The middle points indicate grayscales which the three high-order bits provide. In the illustrated embodiment, the grayscales are binary 001000, 010000, 011000, 100000, 101000, 110000, and 111000, i.e., decimal 8, 16, 24, 32, 40, 48, and 56 respectively. The end points indicate grayscales of binary 000000 and 1000000, i.e., decimal 0 and 64 respectively. Thus, a total of nine boundary points are provided based on the three high order bits. The reference voltage generator 300 is configured to provide the DAC 250 with nine reference voltages which correspond to these nine points.

In addition, each of the eight sections has eight grayscales which the three low-order bits provide. Therefore, 6-bit input image data is divided into eight sections, each of which has eight grayscales. A slope in each section is varied based on a voltage difference of the nine boundary points. Curves similar to a conventional gamma correction curve are formed as shown in FIGS. 4 to 6. As described above, the LSB decoder 253 and the resistor ladder 254 divide the sections into respective grayscales based on the three low-order bits of an image data.

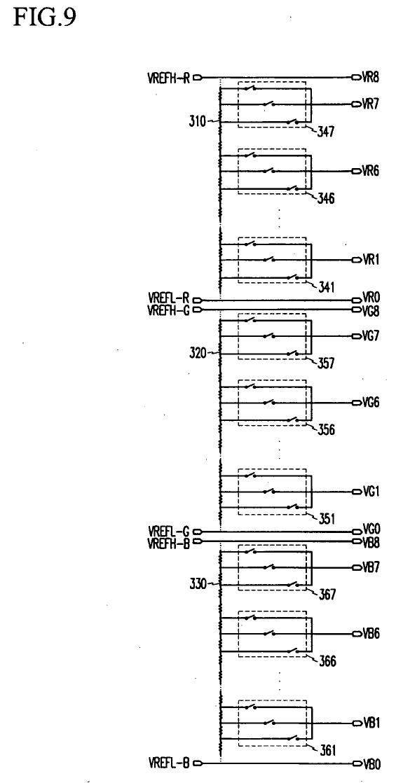

FIG. 9 schematically shows a reference voltage generator 300 according to an embodiment. The reference voltage generator 300 includes an R resistor ladder 310, a G resistor ladder 320, a B resistor ladder 330, R voltage selectors 341-347, G voltage selectors 351-357, and B voltage selectors 361-367.

Each of the R resistor ladder 310, the G resistor ladder 320, and the B resistor ladder 330 has a plurality of resistors in series. The R, G, and B resistor ladders are arranged in a vertical direction as shown in FIG. 9. However, the R resistor ladder 310, the G resistor ladder 320, and the B resistor ladder 330 may be arranged to overlap with each other in a horizontal direction. When the R, G, and B resistor ladders 310, 320, and 330 are arranged in the horizontal direction, circuit wire configuration is complex though wire space can be saved. In one embodiment, the resistor ladders 310, 320, and 330 may be formed of a resistance material on a substrate during a SOP manufacturing process. In certain embodiments, the resistor ladders may be electrical lines including a material having an electrical resistance.

Ends of the respective R, G, and B resistor ladders 310, 320, and 330 are respectively applied with highest reference voltages VREFH-R, VREFH-G, and VREFH-B and lowest reference voltages VREFL-R, VREFL-G, and VREFL-B. In one embodiment, the highest reference voltages VREFH-R, VREFH-G, and VREFH-B and the lowest reference voltages VREFL-R, VREFL-G, and VREFL-B may be different from each other depending on gamma characteristics of organic light emitting materials for the respective colors.

The R voltage selectors 341-347, G voltage selectors 351-357, and B voltage selectors 361-367 are coupled to the R resistor ladder 310, G resistor ladder 320, and B resistor ladder 330, respectively. Each of the R voltage selectors 341-347, G voltage selectors 351-357, and B voltage selectors 361-367 is coupled to a plurality of nodes between the resistors in series. The selectors are configured to output reference voltages between the highest reference voltages VREFH-R, VREFH-G, and VREFH-B and the lowest reference voltages VREFL-R, VREFL-G, and VREFL-B. Each of the voltage selectors includes a plurality of switches. Each of the switches is coupled to a respective one of the nodes in the resistor ladders. The voltage selectors can select one reference voltage by turning on one of the switches.

In the illustrated embodiment, the voltage selectors 341-347, 351-357, and 361-367 are configured to provide reference voltages corresponding to the boundary points described above. The reference voltages have gamma-corrected values for input image data. The voltage selectors are configured to draw an appropriate reference voltage from the resistor ladders 310, 320, and 330 by connecting to one of the nodes in the resistor ladder.

In an embodiment where nine boundary points are provided, seven voltage selectors 341-347, 351-357, and 361-367 are arranged to provide respective reference voltages as shown in FIG. 9. However, the highest and the lowest reference voltages VREFH-R, VREFH-G, VREFH-B, VREFL-R, VREFL-G, and VREFL-B are directly provided to the DAC 250 without a voltage selector. In certain embodiments, the R voltage selectors 341-347, G voltage selectors 351-357, and B voltage selectors 361-367 may be connected to resistor ladders having different resistance so as to generate different reference voltages. In the illustrated embodiment, each of the voltage selectors 341-347, 351-357, and 361-367 includes three switches. Thus, each of the voltage selectors can select one voltage from three input voltages. Then, the voltage selectors output the selected voltage as a reference voltage to the DAC 250.

In one embodiment, R, G, B reference voltages are configured to differ from each other to compensate for gamma characteristic differences between the colors. R, G, B reference voltages are drawn from the resistor ladders. Thus, the R, G, B reference voltages can be made different by applying different highest and lowest reference voltages to the resistor ladders for the respective colors. Accordingly, the DAC 250 may control a data voltage output to the display 100 by controlling the highest and lowest reference voltages of the respective colors. For example, when the highest and lowest reference voltages of the respective colors are increased, a data voltage applied to the display 100 is also increased. Accordingly, the brightness of an image output from the OLED display is decreased. When the highest and lowest reference voltages of the respective colors are decreased, the data voltage is increased. Thus, the brightness of the image output from the OLED display is increased.

As explained above, an amorphous silicon layer is transformed to a polysilicon layer to form a thin film transistor. This transformation is achieved through a low temperature polysilicon (LTPS) process. The process may cause SOP-type OLED displays to have gamma characteristics different from each other. Therefore, it may not be appropriate to provide the same gamma correction circuit to all OLED displays. In the embodiment described above, the reference voltage generator 300 may provide different gamma-corrected reference voltages for different OLED displays. Thus, an optimal gamma correction can be provided for an OLED display.

In addition, the DAC 250 may control a data voltage output to the display 100 by controlling the highest and the lowest reference voltages applied to the reference voltage generator 300.

In addition, the OLED display can perform gamma correction optimized for the respective colors. The OLED display may separately perform gamma correction for different color subpixels. The gamma correction is performed by choosing appropriate reference voltages for OLED materials for each of the colors.

Furthermore, the OLED display can display an image optimized for the brightness of the ambient environment. This feature can be provided by controlling the reference voltages generated from the reference voltage generator 300 based on the brightness of the environment. For example, when an OLED display is in a bright environment, the brightness of the OLED display may be increased by decreasing a level of the data voltage. This can be carried out by decreasing the highest and lowest reference voltages applied to the reference voltage generator. On the other hand, when the OLED display is in a dark environment, the brightness of the OLED display may be decreased. This can be achieved by increasing the level of data voltage. In such a way, the OLED display can adjust the brightness of its image depending on the ambient light. Therefore, high visibility with minimum power consumption may be achieved.

Another aspect of the invention provides an electronic device including the OLED display described above. Examples of the electronic device include, but are not limited to, consumer electronic products, electronic circuit components, parts of the consumer electronic products, electronic test equipments, etc. The consumer electronic products may include, but are not limited to a mobile phone, a telephone, a television, a computer monitor, a desktop or laptop computer, a hand-held computer, a personal digital assistant (PDA), a vehicle navigation system, a global positioning system (GPS), a microwave, a refrigerator, a stereo system, a cassette recorder or player, a DVD player, a CD player, a VCR, an MP3 player, a radio, a camcorder, a camera, a digital camera, a portable memory chip, a watch, a clock, a washer, a dryer, a washer/dryer, a copier, a facsimile machine, a scanner, a multi functional peripheral device, etc.

Although various embodiments of the invention have been shown and described, it will be appreciated by those technologists in the art that changes might be made in these embodiments without departing from the principles and spirit of the invention, the scope of which is defined in the claims and their equivalents.

What is claimed is:

1. An organic light emitting diode (OLED) display comprising:
a plurality of pixels, each of the pixels comprising at least one OLED;
a reference voltage generator configured to provide a plurality of reference voltages, each of the reference voltages being adjustable for the at least one OLED; and
a data driver configured to convert a digital video signal into an analog video signal and to supply the analog video signal to the plurality of pixels,
wherein the data driver is configured to provide the analog signal based on at least one of the reference voltages.

2. The OLED display of claim 1, wherein each of the pixels comprises a plurality of OLEDs, each OLED having a different color, and wherein the reference voltage generator is configured to provide a selected reference voltage for each OLED of a particular color.

3. The OLED display of claim 2, wherein each of the pixels comprises a red OLED, a green OLED, and a blue OLED.

4. The OLED display of claim 1, wherein the reference voltages comprise gamma-corrected voltage values.

5. The OLED display of claim 1, wherein the reference voltages comprise voltage values adjusted according to the ambient light of the OLED display.

6. The OLED display of claim 1, wherein the digital video signal comprises grayscale data of an image to be displayed by the plurality of pixels.

7. The OLED display of claim 1, wherein the reference voltage generator comprises:
a resistor ladder connected between a highest reference voltage and a lowest reference voltage, the resistor ladder comprising a plurality of resistors arranged in series between the highest and the lowest reference voltages and a plurality of nodes between adjacent pairs of the plurality of the resistors; and
a plurality of voltage selectors configured to provide the plurality of reference voltages, each of the voltage selectors comprising a plurality of switches, each of the switches being coupled to a respective one of the plurality of nodes.

8. The OLED display of claim 7, wherein the pixels comprise OLEDs for a plurality of colors and wherein the reference voltage generator comprises a plurality of resistor ladders, each resistor ladder being associated with a respective color.

9. The OLED display of claim 8, wherein the resistor ladders are provided with different highest and lowest reference voltages for the respective color OLEDs.

10. The OLED display of claim 7, wherein the reference voltage generator further provides the highest and the lowest reference voltages as reference voltages.

11. The OLED display of claim 1, wherein the data driver comprises:
a first decoder configured to select two reference voltages from the plurality of the reference voltages according to the digital video signal; and
a second decoder configured to select a reference voltage between the two selected reference voltages according to the digital video signal.

12. The OLED display of claim 11, wherein the data driver further comprises a resistor ladder;
wherein the resistor ladder comprises two terminals, a plurality of resistors arranged in series between the two terminals, and a plurality of nodes between adjacent two of the resistors;
wherein the two terminals are coupled to the two selected reference voltages; and
wherein the second decoder is configured to select one of the two terminals and the plurality of nodes according to the digital video signal.

13. The OLED display of claim 12, wherein the second decoder comprises a plurality of switches, each of the switches being coupled to a respective one of the two terminals and the plurality of nodes.

14. The OLED display of claim 11, wherein the first decoder is configured to select the two reference voltages according to at least one high-order bit of the digital video signal and wherein the second decoder is configured to select the reference voltage according to the remaining low-order bits of the digital video signal.

15. The OLED display of claim 1, wherein the pixels, the reference voltage generator, and the data driver are formed on the same panel.

16. An organic light emitting diode (OLED) display comprising:
a plurality of pixels formed on a substrate and respectively including a plurality of subpixels of first to third colors;
a first resistor provided on the substrate in a form of an electrical line having a resistance and applied with a first highest reference voltage and a first lowest reference voltage at lateral ends of the first resistor, respectively;
a second resistor provided on the substrate in a form of an electrical line having a resistance and applied with a second highest reference voltage and a second lowest reference voltage at lateral ends of the second resistor, respectively;
a third resistor provided on the substrate in a form of an electrical line having a resistance, and applied with a third highest reference voltage and a third lowest reference voltage at lateral ends of the third resistor, respectively;
a predetermined number of first voltage selectors formed on the substrate, coupled to the first resistor through at least one first switch, for selecting a first reference voltage using the first switch;
a predetermined number of second voltage selectors formed on the substrate, coupled to the second resistor through at least one second switch, for selecting a second reference voltage using the second switch;
a predetermined number of third voltage selectors formed on the substrate, coupled to the third resistor through at least one third switch, for selecting a third reference voltage using the third switch; and
a data driver formed on the substrate, for changing video signals respectively corresponding to the plurality of subpixels to data voltages on the basis of the first to third reference voltages, and respectively applying the data voltages to the plurality of subpixels.

17. The OLED display of claim 16, wherein the pluralities of first to third reference voltages are data voltages respectively corresponding to predetermined grayscales of the video signals corresponding to the plurality of subpixels.

18. The OLED of claim 16, wherein the data driver comprises:
a first decoder for selecting pairs of first to third reference voltages among the pluralities of first to the third reference voltages;
a plurality of first resistors arranged in series between the selected pair of first reference voltages;
a plurality of second resistors arranged in series between the selected pair of second reference voltages;
a plurality of third resistors arranged in series between the selected pair of third reference voltages; and
a second decoder for selecting a node corresponding to a grayscale of the video signal among nodes formed by the first to third resistors arranged in series, from bits of the grayscales of the video signal excluding the at least one most significant bit.

19. The OLED display of claim 16, wherein the first to third highest reference voltages are set to be different from each other and the first to third lowest reference voltages are set to be different from each other.

20. A method of providing a video signal to an OLED display, the method comprising:
providing a plurality of pixels, each of the pixels comprising at least one OLED;
providing a plurality of reference voltages adjusted for the at least one OLED;
converting a digital video signal into an analog video signal, using the at least one of the reference voltages; and
providing the analog video signal to the plurality of pixels.

21. The method of claim 20, wherein the pixels comprise OLEDs of at least two different colors and wherein providing the plurality of reference voltages comprises providing different reference voltages to the OLEDs of the different colors.
